(19) United States
(12) Patent Application Publication
(10) Pub. No.: US 2008/0074281 A1
(43) Pub. Date: Mar. 27, 2008

(54) REMOTE CONTROL TRANSMITTER WHICH IS CAPABLE OF CONTROLLING A PLURALITY OF LIGHT FITTINGS WITHOUT THE NEED FOR A SLIDABLE SWITCH

(76) Inventor: Katsuyuki Okimura, Tokyo (JP)

Correspondence Address: HAYES SOLOWAY P.C., 3450 E. SUNRISE DRIVE, SUITE 140, TUCSON, AZ, 85718, US

(21) Appl. No.: 11/838,837

(22) Filed: Aug. 14, 2007

(30) Foreign Application Priority Data
Sep. 21, 2006 (JP) 2006-255821

(51) Int. Cl. H04Q 3/00

(52) U.S. Cl. 340/825

(57) ABSTRACT

A remote control transmitter is capable of controlling a plurality of light fittings without the need for a slidable switch. The remote control transmitter includes a memory for storing data representing a plurality of control signals for respective channels corresponding respectively to the light fittings, a sensor for detecting an angular velocity or an acceleration and outputting a signal based on the detected angular velocity or acceleration, a transmitter for outputting a control signal based on the data stored in the memory, and a controller for setting one of the channels depending on the angular velocity or acceleration detected by the sensor, and for controlling the transmitter to output a control signal based on the data stored in the memory in association with the set channel.

### This application is based upon and claims the benefit of priority from Japanese Patent Application No. 2006-255821 filed on Sep. 21, 2006, the content of which is incorporated by reference.

### BACKGROUND OF THE INVENTION

1. Field of the Invention

The present invention relates to a remote control transmitter for transmitting remote control signals to remotely controlled light fittings.

2. Description of the Related Art

Some remote control transmitters for use with remotely controlled light fittings include a slidable channel selector switch for controlling a plurality of light fittings, as disclosed in Japanese patent No. 3164158, for example.

FIG. 1 of the accompanying drawings is a block diagram showing such a remote control transmitter of the related art for use with remotely controlled light fittings.

As shown in FIG. 1, the remote control transmitter of the related art comprises channel selector switch 1 for selecting a light fitting to be controlled, operation button 2 for starting to operate the selected light fitting, controller 3 for outputting a control signal corresponding to a channel set by channel selector switch 1, transmitter 4 for transmitting the control signal output from controller 3 to the light fitting, and memory 5 for storing data including control signals for respective channels corresponding to the light fittings. The remote control transmitter also includes a cell (not shown) for supplying electric power to controller 3.

It is assumed that the remote control transmitter of the related art has two channels, one referred to as channel 1 and the other as channel 2.

When operation button 2 is pressed, each of the light fittings is operable selectively in different modes, e.g., a turn-on mode, a turn-off mode, and a dimmer control mode.

When operation button 2 is pressed, while either channel 1 or channel 2 is being set by channel selector switch 1, controller 3 outputs a control signal representing operation details of the light fitting stored in association with the set channel. The control signal output from controller 3 is transmitted from transmitter 4.

When the light fitting corresponding to the channel set by channel selector switch 1 receives the control signal, the light fitting starts to operate.

If a slidable switch is used as channel selector switch 1 for controlling the light fittings, then channel selector switch 1 may possibly suffer the following problems:

The slidable switch includes parts that are usually joined by soldering.

If stress greater than an allowable level is applied to the soldered parts when the slidable switch is operated to change the channels, or if the slidable switch is used beyond an allowed period of time, then solder cracks tend to develop to an extent that the slidable switch is no longer operable to change the channels, In addition, it is necessary that the slidable switch be disposed in a highly accurate position. If the slidable switch is not installed in a position in accordance with the design specifications, then the switch may come into contact with the casing of the remote control transmitter which will prevent it from performing a sliding action.

### SUMMARY OF THE INVENTION

It is an exemplary object of the present invention to provide a remote control transmitter which is capable of controlling a plurality of light fittings without the need for a slidable switch.

To achieve the above object, there is provided in accordance with the present invention a remote control transmitter including an operation button for starting to operate a plurality of light fittings, comprising a memory for storing data representing a plurality of control signals for respective channels corresponding respectively to the light fittings, a sensor for detecting an angular velocity or an acceleration and outputting a signal based on the detected angular velocity or acceleration, a transmitter for outputting a control signal based on the data stored in the memory, and a controller for setting one of the channels depending on the angular velocity or acceleration detected by the sensor, and for controlling the transmitter to output a control signal based on the data that is correspond to the set channel stored in the memory.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram of a remote control transmitter according to the related art; and

FIG. 2 is a block diagram of a remote control transmitter according to an embodiment of the present invention.

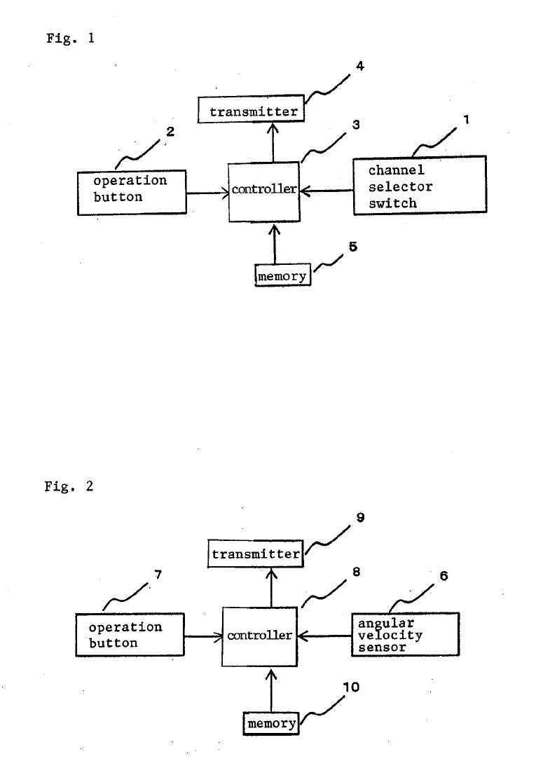

### DETAILED DESCRIPTION OF THE PREFERRED EMBODIMENT

A remote control transmitter according to an embodiment of the present invention will be described in detail below with reference to the drawings.

FIG. 2 shows in block form a remote control transmitter according to an embodiment of the present invention.

As shown in FIG. 2, the remote control transmitter according to the embodiment comprises angular velocity sensor 6 for detecting rotation, operation button 7 for starting to operate light fittings, controller 8 for specifying a channel based on the rotation detected by angular velocity sensor 6 and for outputting a control signal representing the channel and an operation mode of the light fitting, transmitter 9 for transmitting the control signal output from controller 8 to the light fitting, and memory 10 for storing data indicative of control signals for respective channels corresponding to the light fittings. The remote control transmitter also includes a cell (not shown) for supplying electric power to controller 8.

It is assumed that the remote control transmitter has two channels, one referred to as channel 1 and the other as channel 2.

Operation button 7 is mounted on a surface of the casing of the remote control transmitter. Structural details of operation button 7 are identical to those of the operation button of the remote control transmitter of the related art, and will not be described in detail below.

When the remote control transmitter is rotated, angular velocity sensor 6 detects the angular velocity of the rotation, and outputs a signal based on the detected angular velocity to controller 8. Angular velocity sensor 6 may comprise a vibrating piezoelectric device for detecting rotation and outputting a signal based on the angular velocity.

If angular velocity sensor 6 detects no angular velocity or if the signal output from angular velocity sensor 6 based on a detected angular velocity is smaller than a predetermined value, then controller 8 reads data that is correspond to channel 1 stored in memory 10. If the signal output from angular velocity sensor 6 is greater than the predetermined value, then controller 8 reads data that is correspond to channel 2 stored in memory 10. In this manner, controller 8 sets a channel.

When operation button 7 is pressed, controller 8 reads a control signal representing the set channel and the operation mode of the light fitting from the data stored in memory 10, and outputs the control signal to transmitter 9. If the set channel is channel 2, then when the transmission of the control signal to transmitter 9 is completed, controller 8 sets the channel to channel 1.

Operation of the remote control transmitter according to the present embodiment will be described below. It is assumed that the user controls the operation of the light fitting that corresponds to channel 2.

When the user rotates the remote control transmitter by a twisting movement of the wrist of his hand that is holding the remote control transmitter, for example, if the signal output from angular velocity sensor 6 is greater than the predetermined value, then the channel set by controller 8 is channel2.

Then, when the user presses operation button 7, controller 8 outputs a control signal that represents channel 2 and the operation mode of the light fitting to transmitter 9. When the transmission of the control signal to transmitter 9 is completed, controller 8 sets the channel to channel 1.

If the user intends to control the operation of the light fitting that corresponds to channel 1, then the user may press operation button 7 without rotating the remote control transmitter. Specifically, the user may press operation button 7 either without allowing angular velocity sensor 6 to detect any rotation or so that the signal output from angular velocity sensor 6 based on any detected angular velocity is smaller than the predetermined value.

The remote control transmitter may include an acceleration sensor instead of the angular velocity sensor. In order for an acceleration sensor to output a signal based on a detected acceleration, the acceleration sensor detects a voltage based on a change in resistance or electrostatic capacitance that is caused when the acceleration is applied to the acceleration sensor, for example.

In case an acceleration sensor is used, controller 8 sets the channel to channel2 and reads data that is correspond to channel2 stored in memory 10 if a signal detected by the acceleration sensor based on an applied acceleration is greater than a predetermined value. If no acceleration is detected by the acceleration sensor or if the signal detected by the acceleration sensor is smaller than the predetermined value, controller 8 sets channel to channel1 and reads data that is correspond to channel1 stored in memory 10. If the set channel is channel 2, then when the transmission of the control signal to transmitter 9 is completed, controller 8 set the channel to channel 1.

As described above, the remote control transmitter according to the present embodiment stores data representing the two channels, i.e., channel I and channel 2, and the operation modes of the light fittings. If the signal detected based on the angular velocity or the acceleration that is applied to the remote control transmitter is greater than the predetermined value, then the remote control transmitter sets the channel to channel 2. When the operation button is then pressed, the remote control transmitter reads a control signal representing channel 2 and the operation mode of the light fitting from the data, and transmits the control signal. When the output of the control signal is completed, the remote control transmitter sets the channel to channel 1.

Since the channel read from the data is specified by detecting an angular velocity or an acceleration applied to the remote control transmitter, the remote control transmitter can change the channels without the need for a switch that requiring a slidable operation. The user can change the channel setting from channel 1 to channel 2 by rotating the remote control transmitter or moving the remote control transmitter sideways or up and down, for thereby independently controlling the light fittings assigned respectively to the different two channels.

If the remote control transmitter employs an angular velocity sensor capable of identifying the direction of rotation from the detected rotation, then the remote control transmitter can set the channel to channel 1 when it detects a right-hand (clockwise) rotation and to channel 2 when it detects a left-hand (counterclockwise) rotation. In this case, once the remote control transmitter sets a channel, the channel is left unchanged.

To change the channel setting from channel 1 to channel 2, the user may rotate the remote control transmitter to the left, i.e., counterclockwise. Conversely, to change the channel setting from channel 2 to channel 1, the user may rotate the remote control transmitter to the right, i.e., clockwise.

The remote control transmitter is not limited to being used in combination with light fittings, but may be used to operate AV (Audio Visual) devices including television sets and video decks. In these applications, the remote control transmitter can change channels in remote controlled devices from a television set to a video deck, for example, based on a detected angular velocity or a detected acceleration.

The channels that can be set by the remote control transmitter are not limited to two channels, but may be three or more channels. If three or more channels are to be set by the remote control transmitter, then the remote control transmitter may make a channel setting based on the number of times that it has detected an angular velocity or an acceleration.

According to the present invention, since a channel is depending on an angular velocity or an acceleration that is detected, it is possible to control a plurality of light fittings without the need for a switch that requiring a slidable operation. The user can control a plurality of light settings by rotating the remote control transmitter or moving the remote control transmitter sideways or up and down to change channels.

While preferred embodiments of the present invention have been described using specific terms, such description is for illustrative purposes only, and it is to be understood that changes and variations may be made without departing from the spirit or scope of the following claims.

1. A remote control transmitter including an operation button for starting to operate a plurality of light fittings, comprising:
a memory for storing data representing a plurality of control signals for respective channels corresponding respectively to the light fittings;
a sensor for detecting an angular velocity or an acceleration and outputting a signal based on the detected angular velocity or acceleration;
a transmitter for outputting a control signal based on the data stored in said memory; and
a controller for setting one of the channels depending on the angular velocity or acceleration detected by said sensor, and controlling said transmitter to output a control signal based on the data stored in said memory in association with the set channel.

2. The remote control transmitter according to claim 1, wherein said channels include a first channel and a second channel;
said controller sets said first channel if said sensor detects no angular velocity or no acceleration or if the signal output from said sensor is smaller than a predetermined value, and sets said second channel if the signal output from said sensor is greater than said predetermined value; and
if the set channel is the second channel, said controller changes the set channel from said second channel to said first channel after said transmitter has output said control signal.

3. The remote control transmitter according to claim 1, wherein said controller sets one of said channels based on the number of times that said sensor has detected an angular velocity or an acceleration.

4. A remote control transmitter including an operation button for starting to operate first and second light fittings, comprising:
a memory for storing data representing a plurality of control signals for respective first and second channels corresponding respectively to said first and second light fittings;
a sensor for detecting an angular velocity or an acceleration and outputting a signal based on the detected angular velocity or acceleration;
a transmitter for outputting a control signal based on the data stored in said memory; and
a controller for setting said first channel when said sensor detects a right-hand rotation, setting said second channel when said sensor detects a left-hand rotation, and controlling said transmitter to output a control signal based on the data stored in said memory in association with the set channel.
